(19) United States
(12) Patent Application Publication
(10) Pub. No.: US 2009/0216705 A1
(43) Pub. Date: Aug. 27, 2009

(54) METHOD FOR PREDICTING SUGAR CHAIN STRUCTURE

(75) Inventors: Akihiko Kameyama, Ibaraki (JP); Norihiro Kikuchi, Tokyo (JP); Shuuichi Nakaya, Kyoto (JP); Hideki Ishida, Tokyo (JP); Hisashi Narimatsu, Ibaraki (JP)

Correspondence Address: SUGHRUE MION, PLLC, 2100 PENNSYLVANIA AVENUE, N.W., SUITE 800, WASHINGTON, DC, 20037, US

(73) Assignees: National Institute of Advanced Industrial Science and Technology, Tokyo (JP); Mitsui Knowledge Industry Co., Ltd., Tokyo (JP); Shimadzu Corporation, Kyoto (JP)

(21) Appl. No.: 11/911,345

(22) PCT Filed: Apr. 13, 2006
(86) PCT No.: PCT/JP2006/307812

§ 371 Date: Jan. 23, 2009

(30) Foreign Application Priority Data
Apr. 13, 2005 (JP) 2005-115866

(51) Int. Cl. G06N 5/02; B01D 59/44; H01J 49/00

(52) U.S. Cl. 706/54; 250/282; 250/281

(57) ABSTRACT

An object of the present invention is to provide a method for conveniently analyzing sugar chain (isomer) structure using a sample of approximately 1 picomole, which is generally subjected to analysis in proteomics without using any sugar chain preparation. The present invention relates to a method for analyzing sugar chain structure, comprising a step of obtaining the fragmentation pattern of a test sugar chain through fragmentation of the test sugar chain and a step of predicting the structure of the test sugar chain through comparison of the sugar chain predicted fragmentation pattern data generated based on fragmentation pattern templates with the fragmentation pattern of the test sugar chain.

### TECHNICAL FIELD

The present invention relates to a system for analyzing sugar chain structure using a mass spectrometer.

### BACKGROUND ART

Characterization of a proteome is very difficult because of non-uniformity due to posttranslational modification such as glycosylation. Oligosaccharides of glycoproteins play important roles in biological processes in terms of stability, protein conformation, and intracellular and intercellular signaling, as well as binding affinity and specificity for other biomolecules, for example. Hence, the structural analysis of oligosaccharides is important for understanding of glycoprotein functions at the molecular level. However, there are a plurality of isomers (e.g., structural isomers, regioisomers, stereoisomers, and branched isomers) of a given sugar chain, which have the same sequence order, but different structures. Therefore, unlike DNA and protein, the structures of which can be specified by simply analyzing the sequences thereof, structural analysis of a sugar chain has been difficult. Furthermore, these isomers are thought to have different functions in vivo. Thus, when a sugar chain structure is analyzed, a means for distinguishing these isomers has been desired. Isomers of a sugar chain have thus far been analyzed by methylation analysis using NMR and GC-MS. However, such methods have been problematic in that they require milligram-scale samples.

Meanwhile, mass spectrometry can be considered to be a powerful means for analyzing oligosaccharides with high sensitivity and high throughput. A method for automatically estimating sugar chain structure based on the spectrum obtained as a result of sugar chain fragmentation within a mass spectrometer is reported in Rapid Communication in Mass Spectrometry, 16, p. 1743, 2002, Automated structural assignment of derivatized complex type N-linked oligosaccharides from tandem mass spectra. A method for automatically estimating sugar chain structure based on the spectrum obtained as a result of sugar chain fragmentation (in the case of postsource decay) within a mass spectrometer is reported in Analytical Chemistry, 71, p. 4764, 1999, An Automated Interpretation of MALDI/TOF Postsource Decay Spectra of Oligosaccharides. 1. Automated Peak Assignment. A method for estimating sugar chain structure is reported in Proteomics, 4, p. 1650, 2004, Development of a mass fingerprinting tool for automated interpretation of oligosaccharide fragmentation data, which involves calculating within a mass spectrometer all the possible fragmentation patterns (e.g., combinations or permutations) of sugar chains that have been reported so far and performing matching of such patterns with the fragmentation pattern of a test sugar chain. However, it is impossible to distinguish isomers having the same sequence order with the use of such method.

### DISCLOSURE OF THE INVENTION

An object of the present invention is to provide a method for conveniently analyzing sugar chain (isomer) structure using a sample of approximately 1 picomole, which is generally subjected to analysis in proteomics without using any sugar chain preparation.

The present inventors have applied for a patent for a method for predicting sugar chain structure, which comprises obtaining fragmentation patterns through actual fragmentation of a huge variety of sugar chains that are confirmed to exist, accumulating the results as data, and then comparing the accumulated fragmentation pattern data with the fragmentation pattern of a test sugar chain. This method requires to prepare preparations of a huge variety of sugar chains and to obtain fragmentation patterns via actual fragmentation. It may be difficult to obtain such preparations for a huge variety of sugar chains.

Accordingly, the present inventors have synthesized sugar chains that are labeled site-specifically in their structures with a stable isotope, following which the ease of fragmentation of specific bonds is converted into numerical values based on the fragmentation patterns thereof. With the use of a list of the numerical values, the present inventors have discovered that the structure of a test sugar chain can be identified by predicting what kind of a fragmentation pattern would be exerted by each sugar chain and comparing such pattern with actually measured patterns. Thus, the present inventors have completed the present invention.

The present invention encompasses the following:

(1) a method for analyzing sugar chain structure, comprising a step of obtaining the fragmentation pattern of a test sugar chain through fragmentation of the test sugar chain and a step of predicting the structure of the test sugar chain through comparison of sugar chain predicted fragmentation pattern data generated based on fragmentation pattern templates with the fragmentation pattern of the test sugar chain;
(2) the method according to (1), wherein the test sugar chain quantity ranges from 0.01 picomoles to 100 picomoles;
(3) the method according to (1) or (2), wherein the step of obtaining the fragmentation pattern of a test sugar chain through fragmentation of the test sugar chain includes a step of obtaining the mass and the signal intensity of each fragment through analysis of the fragmented test sugar chain in a mass spectrometer;
(4) the method according to (3), wherein the step of predicting the structure of the test sugar chain is a step of predicting sugar chain structure through comparison of the signal intensity ratios of fragments in the fragmentation patterns;
(5) a system for analyzing sugar chain structure, comprising
a fragmentation pattern measurement apparatus for fragmenting a test sugar chain and measuring the fragmentation pattern of the fragmented test sugar chain,
a fragmentation pattern memory device for storing sugar chain predicted fragmentation pattern data generated based on fragmentation pattern templates,
a matching apparatus for comparing the predicted fragmentation pattern data stored in the fragmentation pattern memory device with the fragmentation pattern measured using the apparatus for measuring a fragmentation pattern,
and a sugar chain structure display device for displaying the sugar chain structure predicted based on comparisons made in the matching apparatus;
(6) the system for analyzing sugar chain structure according to (5), wherein the apparatus for measuring a fragmentation pattern is a mass spectrometer;
(7) the system for analyzing sugar chain structure according to (6), wherein the matching apparatus is an apparatus for comparing the signal intensity ratios of fragments in the fragmentation patterns;
(8) the system for analyzing sugar chain structure according to any one of (5) to (7), wherein the apparatus for measuring a fragmentation pattern contains a collision-induced dissociation apparatus;
(9) a method for predicting the fragmentation pattern of a sugar chain, comprising a step of selecting a fragmentation pattern template of a sugar chain having the same basic structure as that of a target sugar chain, and a step of generating the fragmentation pattern of the target sugar chain based on the selected template;
(10) a system for predicting the fragmentation pattern of a sugar chain, comprising
a template memory device for storing fragmentation pattern templates,
a matching apparatus for selecting a template of a sugar chain having the same basic structure as that of a target sugar chain from templates stored in the template memory device,
a fragmentation pattern generation apparatus for generating the fragmentation pattern of the target sugar chain based on the template selected in the matching apparatus, and
a fragmentation pattern display device for displaying the thus obtained fragmentation pattern.

The present invention makes it possible to rapidly analyze sugar chain structure with the use of extremely lower amounts of a sample than in the cases of conventional sugar chain structure analysis methods employing methylation analysis using NMR or GC-MS. The present invention further makes it possible to carry out structural analysis of a sugar chain having an unknown structure without obtaining data on preparations through preliminary obtainment and fragmentation of various sugar chain preparations.

This description includes part or all of the contents as disclosed in the description, claims, and/or drawings of Japanese Patent Application No. 2005-115866, which is a priority document of the present application.

### BRIEF DESCRIPTION OF THE DRAWINGS

FIG. 1 shows UDP-¹³C₆-D-galactose. “*” denotes the position of ¹³C.

FIG. 2 shows a complex type N-linked oligosaccharide set and the isotopomers thereof having ¹³C₆-galactose at complementary positions.

FIG. 3-a shows signal intensity ratios of fragment ions having the same composition at specific m/z values. The structural portions of the fragment ions are shown by shading the portions in the corresponding parent ions. FIG. 3-a shows the results of MS/MS carried out for a biantennary (double-stranded) N-linked oligosaccharide. “†” denotes a dehydration ion.

FIG. 3-b shows the signal intensity ratios of fragment ions having the same composition at specific m/z values. The structural portions of the fragment ions are shown by shading the portions in the corresponding parent ions. FIG. 3-b shows the CID spectrum (MS3 spectrum) obtained using the fragment ion (m/z 1443) (observed in the results of MS/MS carried out for a biantennary N-linked oligosaccharide) as a parent ion. “†” denotes a dehydration ion.

FIG. 3-c shows the signal intensity ratios of fragment ions having the same composition at specific m/z values. The structural portions of the fragment ions are shown by shading the portions in the corresponding parent ions. FIG. 3-c shows the results of MS/MS carried out for a triantennary (triple-stranded) N-linked oligosaccharide. “†” denotes a dehydration ion.

FIG. 3-d shows the signal intensity ratios of fragment ions having the same composition at specific m/z values. The structural portions of the fragment ions are shown by shading the portions in the corresponding parent ions. FIG. 3-d shows the results of MS/MS carried out for a tetraantennary (four-stranded) N-linked oligosaccharide. “†” denotes a dehydration ion.

FIG. 4-a shows a fragmentation pattern template of a complex type N-linked oligosaccharide represented by the CID spectrum. Specifically, fragment ion structures and signal intensity ratios (%) thereof are shown. FIG. 4-a shows the fragmentation pattern template of a biantennary N-linked oligosaccharide. “†” denotes a dehydration ion. “x” denotes an arbitrary sugar residue.

FIG. 4-b shows a fragmentation pattern template represented by the CID spectrum of a complex type N-linked oligosaccharide. Specifically, fragment ion structures and signal intensity ratios (%) thereof are shown. FIG. 4-b shows the fragmentation pattern template of a triantennary N-linked oligosaccharide. “†” denotes a dehydration ion. “x” denotes an arbitrary sugar residue.

FIG. 5 shows three types of oligosaccharide used for fragmentation pattern simulation.

FIG. 6-a shows a comparison of predicted spectra obtained by simulation with actual spectra. FIG. 6-a shows the predicted spectra obtained by simulation.

FIG. 6-b shows a comparison of predicted spectra obtained by simulation with actual spectra. FIG. 6-b shows the actual spectra.

FIG. 7-1 shows a list of complex type N-linked oligosaccharides for which predicted spectra were produced by the method for predicting a fragmentation pattern of the present invention, following which such predicted spectra were stored in a memory device.

FIG. 7-2 shows a list of complex type N-linked oligosaccharides for which predicted spectra were produced by the method for predicting a fragmentation pattern of the present invention, following which such predicted spectra were stored in a memory device.

FIG. 7-3 shows a list of complex type N-linked oligosaccharides for which predicted spectra were produced by the method for predicting a fragmentation pattern of the present invention, following which such predicted spectra were stored in a memory device.

FIG. 7-4 shows a list of complex type N-linked oligosaccharides for which predicted spectra were produced by the method for predicting a fragmentation pattern of the present invention, following which such predicted spectra were stored in a memory device.

FIG. 7-5 shows a list of complex type N-linked oligosaccharides for which predicted spectra were produced by the method for predicting a fragmentation pattern of the present invention, following which such predicted spectra were stored in a memory device.

FIG. 7-6 shows a list of complex type N-linked oligosaccharides for which predicted spectra were produced by the method for predicting a fragmentation pattern of the present invention, following which such predicted spectra were stored in a memory device.

FIG. 8 shows the structure of a test sugar chain used in Example 3.

FIG. 9 shows the actual CID spectrum of a test sugar chain as obtained by MALDI-QIT-TOF-MS.

FIG. 10 shows the results of calculating (matching) the actual CID spectrum of a test sugar chain with predicted spectra stored in a memory device.

FIG. 11 shows the predicted spectrum of a complex type N-linked oligosaccharide N-12, which was stored in a memory device.

FIG. 12 shows an embodiment of the present invention.

FIG. 13 shows an embodiment of the present invention.

### BEST MODE FOR CARRYING OUT THE INVENTION

### I. Method for Analyzing Sugar Chain Structure and System for Analyzing Sugar Chain Structure

The method for analyzing sugar chain structure of the present invention comprises a step of obtaining the fragmentation pattern of a test sugar chain through fragmentation of the test sugar chain and a step of predicting the structure of the test sugar chain through comparison of the sugar chain predicted fragmentation pattern data generated based on fragmentation pattern templates with the fragmentation pattern of the test sugar chain.

A test sugar chain to be analyzed in the present invention is not particularly limited and is preferably a glycoprotein sugar chain. Examples of such glycoprotein sugar chain include an N-linked (also referred to as an Asn type) sugar chain bound to an asparagine residue of a polypeptide and an O-linked (also referred to as a mucin type) sugar chain bound to a serine or threonine residue. The present invention can be suitably employed for the analysis of an N-linked sugar chain.

An N-linked sugar chain contains a branched pentasaccharide referred to as Manα1→6(Manα1→3)Manβ1→4GlcNAcβ1→4GlcNAc as a common core. N-linked sugar chains of this type are classified into three groups based on sugar chain structures bound to the outside of the core pentasaccharide: a high mannose type wherein an α-mannosyl residue alone is bound to the core pentasaccharide; a complex type wherein one to five side chains beginning from N-acetylglucosamine are bound to two α-mannosyl residues of the core pentasaccharide; and a combined type of the high mannose type and the complex type, which has a combined-type structure wherein side chains similar to those in the case of the complex type are bound to the Manα1→3 side of the core pentasaccharide and one to two α-mannosyl residues are bound to the Manα1→6 side. The complex sugar chain and the combined type sugar chain are further structurally varied based on the presence or the absence of an α-fucosyl residue bound to position C-6 of the base N-acetylglucosamine residue and the presence or the absence of an N-acetylglucosamine residue bound to position C-4 of a β-mannosyl residue of the core pentasaccharide. The present invention may be suitably used for the analysis of, in particular, the complex type N-linked sugar chain, and preferably the complex type N-linked oligosaccharide.

The molecular weight of a sugar chain that can be suitably analyzed by the present invention generally ranges from 300 to 6000, preferably ranges from 900 to 5000, and more preferably ranges from 1200 to 4000.

The method for analyzing a sugar chain structure of the present invention comprises the step of obtaining the fragmentation pattern of a test sugar chain through fragmentation of the test sugar chain. Such fragmentation pattern is composed of fragment types obtained from a test sugar chain and the amount or the ratio of each fragment. In the method of the present invention, the step of obtaining the fragmentation pattern of a test sugar chain through fragmentation of the test sugar chain preferably includes a step of obtaining the mass and the signal intensity of each fragment through analysis of the fragmented test sugar chain in a mass spectrometer.

A mass spectrometer that can be used herein is not particularly limited, as long as it can be used for analyzing sugar chain fragments by mass spectrometry. Mass spectrometers that are generally used in the art can be used. In general, techniques that involve analyzing molecular ions based on differences in mass using electrical interaction are employed. Such a mass spectrometry method involves three steps: ion generation, separation, and detection. Preferably, a tandem mass spectrometer (MS/MS) is employed, which conducts 5 steps: ion generation, ion selection, fragmentation, separation, and detection. Structural analysis can be rapidly carried out using such a tandem mass spectrometer.

Examples of ionization methods (modes) that can be employed for mass spectrometry include a matrix-assisted laser desorption/ionization (MALDI) method, an electron-impact ionization (EI) method, an electrospray ionization (ESI) method, a sonic spray ionization (SSI) method, a photoionization method, an ionization method using a or β rays with large LET radiated from a radioactive isotope, a secondary ionization method, a fast atom bombardment (FAB) ionization method, a electrolytic ionization method, a surface ionization method, a chemical ionization (CI) method, a field ionization (FI) method, a field desorption ionization (FD) method, and an ionization method using spark discharge. Preferable examples include a sonic spray ionization (SSI) method and an electrospray ionization (ESI) and matrix-assisted laser desorption/ionization (MALDI) method. More preferable examples include a matrix-assisted laser desorption/ionization (MALDI) method. Examples of separation modes include a time-of-flight (TOF) type, a single or multiple quadrupole type, a single or multiple magnetic sector type, a Fourier transform ion cyclotron resonance (FTICR) type, an ion trap type, a high-frequency type, and an ion trap/time-of-flight type. The TOF type is preferably employed.

Fragmentation can be carried out by a method that is generally employed in the art. Examples of such method include a collision-induced dissociation (CID) method, an infrared multiphoton dissociation (IRMPD) method, a postsource decay (PSD) method, and a surface-induced dissociation (SID) method. Preferably, a collision-induced dissociation method is employed. The collision-induced dissociation method involves two steps: ion selection and fragmentation. The collision-induced dissociation method can be carried out using an ion trap type, a multiple quadrupole type, a Fourier transform ion cyclotron resonance (FTICR) type, a high-frequency- and ion trap/time-of-flight type, a reflectron time-of-flight type, a multiple time-of-flight type, or a multiple magnetic sector type mass spectrometer. Preferably, the ion trap/time-of-flight type mass spectrometer is used.

Mass spectrometry can also be carried out with a combined use of the above-mentioned ionization method and separation mode, a fragmentation mode, and a detection mode such as electric recording or photographic recording. Preferably, a MALDI-QIT-TOF type is employed. The use of such a MALDI-QIT-TOF-type mass spectrometer enables analysis with an extremely small amount of a sample.

This apparatus is advantageous for carrying out the present invention as described below, for example. The apparatus employs the MALDI method for ionization so that monovalent ions with simple fragmentation patterns tend to be generated and efficient ionization can be achieved even in the presence of small amounts of impurities. The apparatus employs quadrupole ion trap (QIT) as a fragmentation mode, so that the range for ion selection can be precisely controlled and CID energy can be easily controlled. Furthermore, the apparatus employs the TOF method as an ion separation mode, and mass resolution for separation is high.

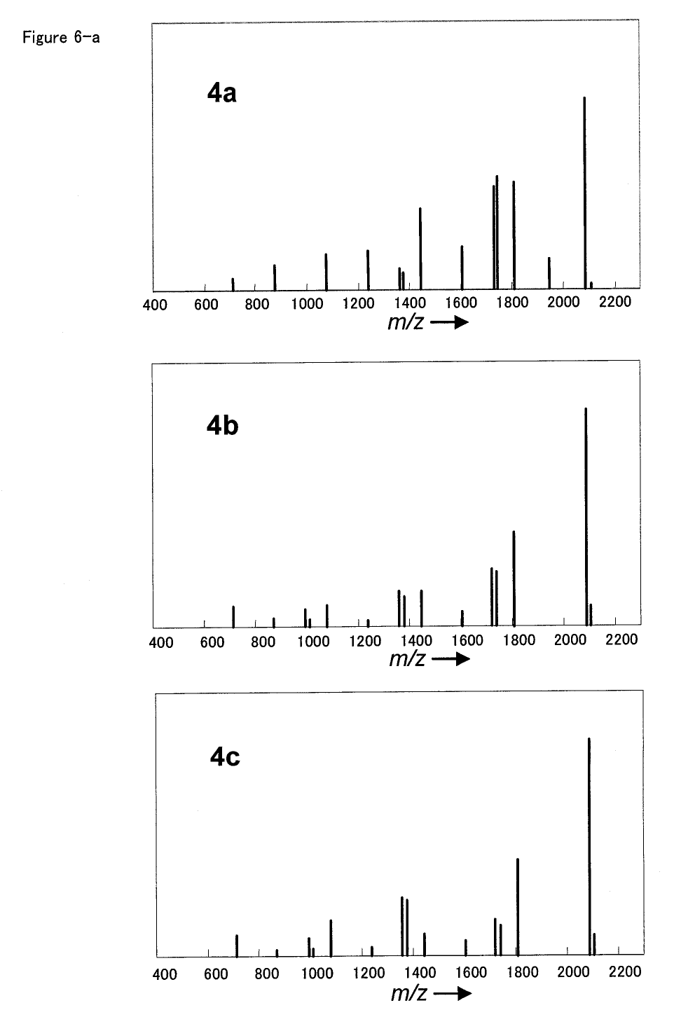

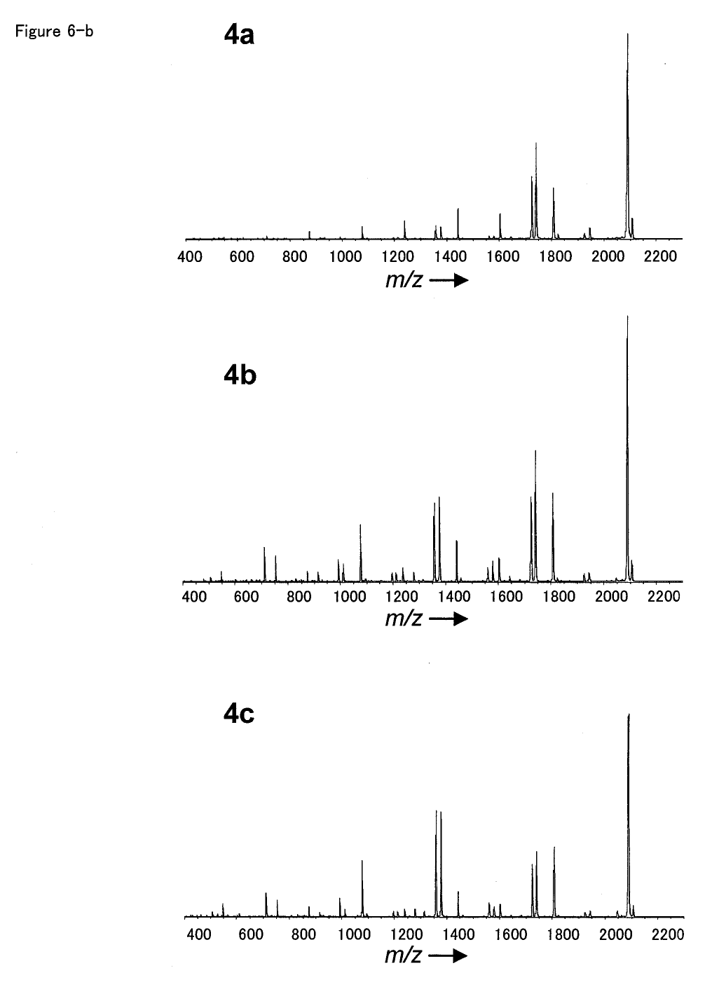

The signal intensity ratio of each fragment ion that appears in a spectrum obtained with the use of a mass spectrometer is quantified for each fragment, so that a fragmentation pattern can be obtained. A method for quantifying signal intensity ratio is not particularly limited, as long as each signal intensity ratio is represented thereby. For example, such signal intensity ratio can be quantified as a relative % with respect to the total of signal intensities. Alternatively, such signal intensity ratio can be quantified as a relative % with respect to specific signal intensity, preferably the maximum signal intensity. Specifically, a fragmentation pattern obtained via mass spectrometry is composed of the masses of fragments that are obtained via fragmentation of a test sugar chain (more specifically, m/z value) and their signal intensity ratios at the obtained masses. A fragmentation pattern is preferably a mass spectrometry spectrum represented by a graph. FIG. 6b shows examples of fragmentation patterns of test sugar chains that were obtained according to the present invention.

The method of the present invention further comprises the step of predicting the structure of a test sugar chain through comparison of sugar chain predicted fragmentation pattern data generated based on fragmentation pattern templates with the fragmentation pattern of the test sugar chain.

Regarding the sugar chain predicted fragmentation patterns, such fragmentation patterns are generated in advance for all sugar chains that can exist based on fragmentation pattern templates and then accumulated as data. Here, such predicted fragmentation pattern differs from an actual fragmentation pattern obtained through actual fragmentation of a sugar chain preparation, and instead is a fragmentation pattern that is predicted and generated through simulation based on fragmentation pattern templates. FIG. 6a shows examples of such predicted fragmentation patterns. The method for generating sugar chain predicted fragmentation patterns based on fragmentation pattern templates is later described in “II. Method for predicting fragment pattern and system for predicting fragmentation pattern.”

For example, for a glycoprotein sugar chain, predicted fragmentation pattern data are generated for each basic structure observed in at least N-linked and O-linked sugar chains. More specifically, a complex type N-linked sugar chain has any of mono- to penta-antennary (single- to five-stranded) branch structures. For such a sugar chain, predicted fragmentation pattern data are generated in advance for at least each branch structure. Subsequently, the thus generated predicted fragmentation pattern data are compared with a fragmentation pattern obtained through actual fragmentation of a test sugar chain, so that the sugar chain structure can be analyzed.

The present inventors have discovered that major differences in fragmentation patterns of complex type N-linked sugar chains result from differences in the tendency of dissociation of GlcNAc glycosidic bonds at branch sites, specifically the bond between two α-mannosyl residues of the core pentasaccharide and a side-chain GlcNAc residue. Accordingly, it is preferable to generate a predicted fragmentation pattern for at least each GlcNAc glycosidic bond type at a branch site. If a given number of predicted fragmentation patterns can be obtained for each structure in the periphery of the core pentasaccharide, predicted fragmentation patterns can be automatically generated and accumulated as data for structures having further extends or branches at its termini. Most preferably, predicted fragmentation patterns are generated and accumulated as data for all sugar chains which have been identified.

Comparison of predicted fragmentation patterns with the fragmentation pattern of a test sugar chain can be mainly carried out by comparing them in terms of fragments generated through dissociation of the bond between two α-mannosyl residues of the core pentasaccharide and a side-chain GlcNAc residue and their signal intensity ratios.

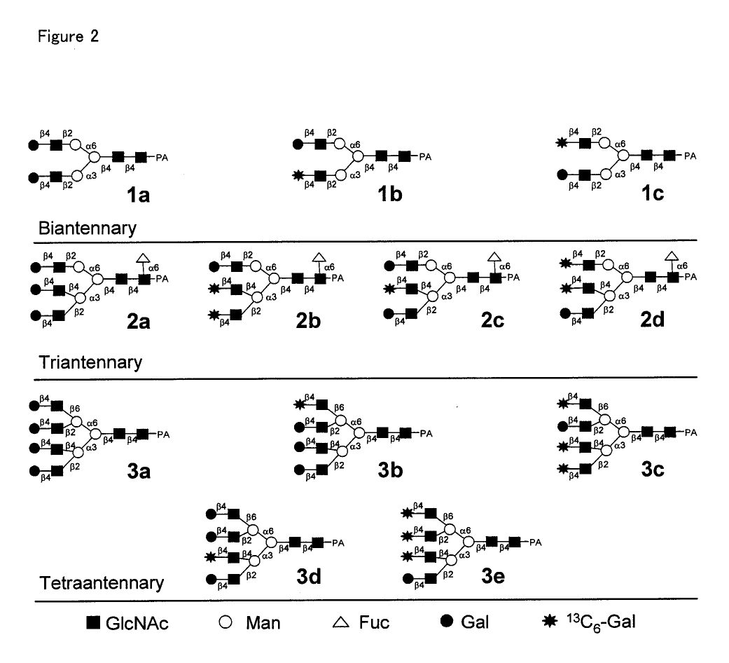

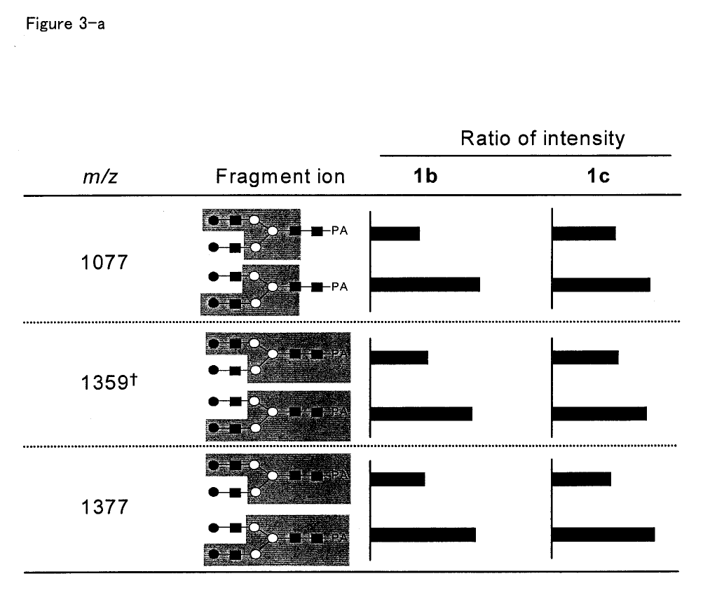

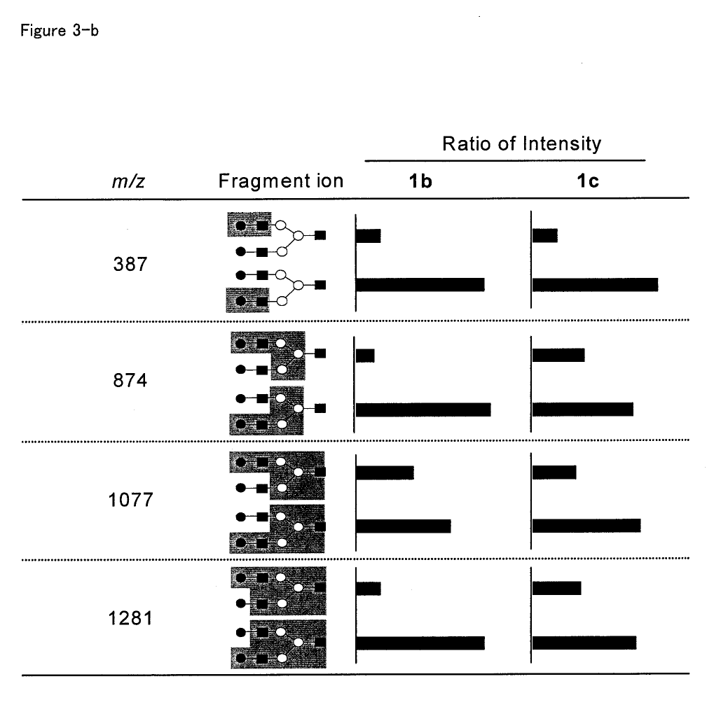

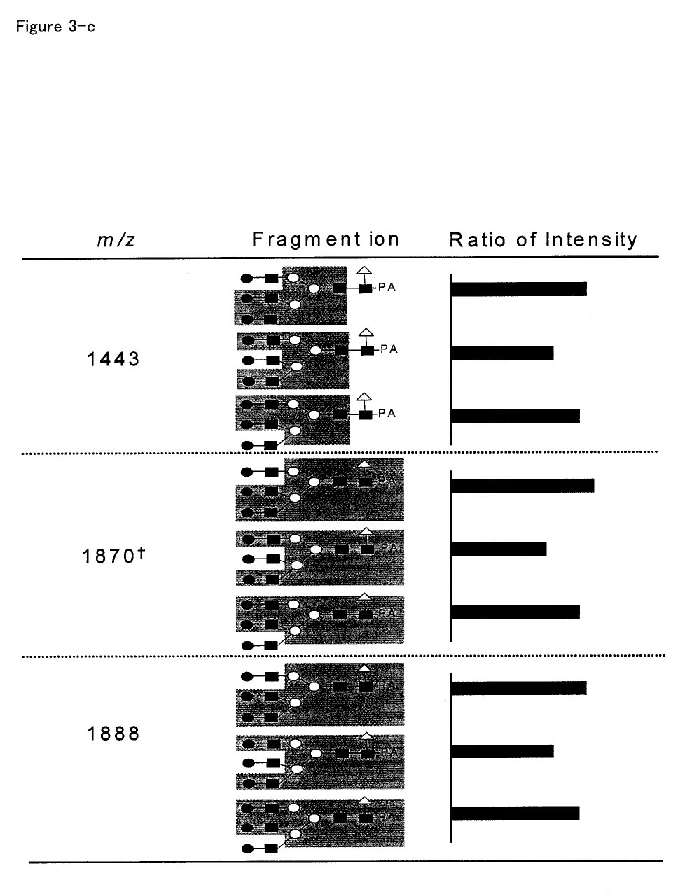

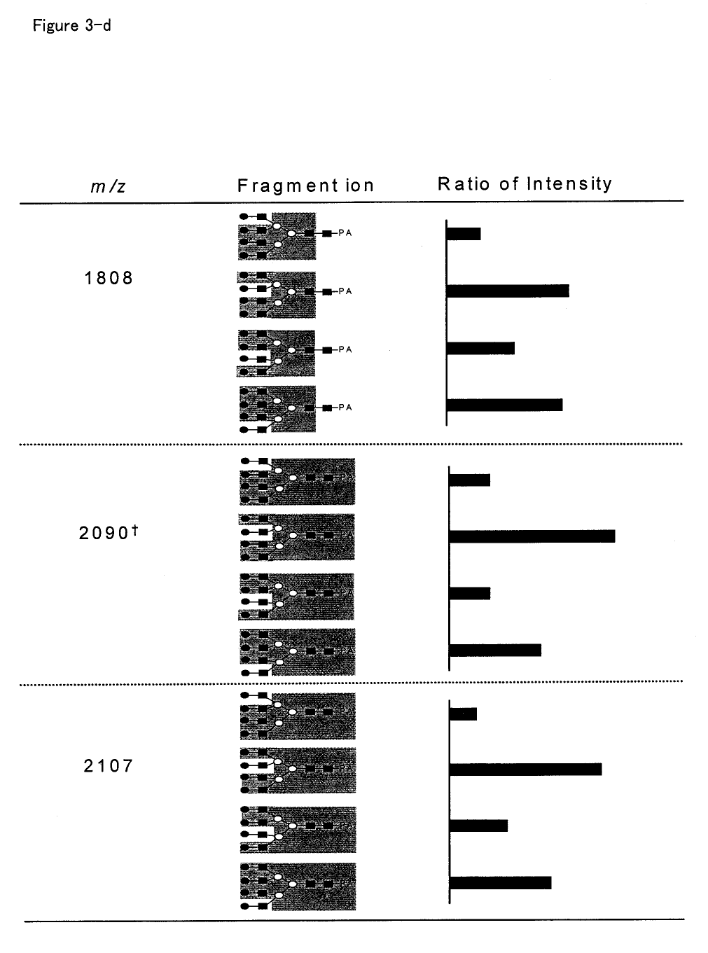

The present inventors have also discovered that the signal intensity ratio derived from a fragment ion resulting from the dissociation of a Galβ1→4GlcNAc residue on the Manα1→6 branch side is larger than that derived from a fragment ion resulting from the dissociation of a Galβ1→4GlcNAc residue on the Manα1→3 branch side (FIGS. 2 and 3). Therefore, comparison can be carried out based on points of agreement or points of difference in the signal intensity ratio derived from a fragment ion resulting from the dissociation of a Galβ1→4GlcNAc residue on the Manα1→6 branch side and the signal intensity ratio derived from a fragment ion resulting from the dissociation of a Galβ1→4GlcNAc residue on the Manα1→3 branch side.

Furthermore, a fragmentation pattern that agrees with or is analogous to that of a test sugar chain is selected from the thus accumulated predicted fragmentation pattern data and then the structure of a sugar chain that is the source of the selected fragmentation pattern can be predicted as the structure of the test sugar chain. Thus, the isomeric structure of a sugar chain can be analyzed.

According to the present invention, the structures of sugar chain isomers having the same composition or sequence are distinguishable. In particular, structural isomers are distinguishable. More specifically, the present invention is advantageous in distinguishing branch structures of complex type N-linked sugar chains.

The quantity of a test sugar chain to be used in the present invention generally ranges from 0.01 to 100 picomoles, preferably ranges from 0.1 to 20 picomoles, and further preferably ranges from 0.5 to 2 picomoles. According to the method of the present invention, the structure of a sugar chain can be analyzed with an extremely small amount of a sample, which is 1/100,000 or below 1/100,000 that used in a conventional method. Hence, the method of the present invention has a great advantage.

The present invention further relates to the system for analyzing sugar chain structure used for carrying out the method of the present invention.

In one aspect of the present invention, the system for analyzing sugar chain structure of the present invention comprises:

a fragmentation pattern memory device for storing sugar chain predicted fragmentation pattern data generated based on fragmentation pattern templates;
a matching apparatus for comparing the predicted fragmentation pattern data stored in the fragmentation pattern memory device with a fragmentation pattern measured using the apparatus for measuring a fragmentation pattern; and
a sugar chain structure display device for displaying the sugar chain structure predicted based on comparison made in the matching apparatus.

In the system for analyzing sugar chain structure of the present invention, the apparatus for measuring a fragmentation pattern is preferably a mass spectrometer. Such a mass spectrometer is as described in connection with the above method for analyzing sugar chain structure. The apparatus for measuring a fragmentation pattern includes an apparatus for fragmentation of a sugar chain. Such an apparatus for fragmentation of a sugar chain is as described in connection with the fragmentation method (mentioned above concerning the method for analyzing sugar chain structure) and is not particularly limited. Preferably, such an apparatus for fragmentation of a sugar chain is a collision-induced dissociation apparatus. The collision-induced dissociation method involves two steps: ion selection and fragmentation, and it can be carried out using an ion trap type, a multiple quadrupole type, a fourier transform ion cyclotron resonance (FTICR) type, a high-frequency type and ion trap/time-of-flight-type, a reflectron time-of-flight type, a multiple time-of-flight type, or a multiple magnetic sector type mass spectrometer. Preferably, the ion trap/time-of-flight type mass spectrometer is used.

The fragmentation pattern memory device is an apparatus for storing predicted fragmentation patterns of a huge variety of sugar chains. Fragmentation pattern memory devices that are generally employed in the art can be used herein. Examples of such devices include hard disks and memories. Such memory devices to be used herein are preferably used for storing predicted fragmentation patterns of all the sugar chains which have been identified.

The matching apparatus is an apparatus for selecting a predicted fragmentation pattern that agrees with or is analogous to that of a test sugar chain through comparison of predicted fragmentation pattern data in the fragmentation pattern memory device with the fragmentation pattern of the test sugar chain. Comparison and selection are carried out via software. In the case of a complex type N-linked sugar chain, comparison is made based on fragments generated from dissociation of the bond between two α-mannosyl residues of the core pentasaccharide and a side-chain GlcNAc residue and their signal intensity ratios.

The sugar chain structure display device is a device for displaying sugar chain structure after prediction of such sugar chain structure (which is the source of the thus selected predicted fragmentation pattern) as the structure of a test sugar chain. An example of such sugar chain structure display device is a display.

### II. Method for Predicting Fragmentation Pattern and System for Predicting Fragmentation Pattern

The present invention further relates to a method for predicting the fragmentation pattern of an arbitrary sugar chain and specifically a method for generating the predicted fragmentation pattern of a sugar chain. The method for predicting a fragmentation pattern of the present invention comprises:

a step of selecting a fragmentation pattern template of a sugar chain having the same basic structure as that of a target sugar chain; and
a step of predicting the fragmentation pattern of the target sugar chain based on the selected template.

Sugar chain fragmentation pattern templates are generated by synthesizing sugar chains each having different sugar chain basic structure wherein their sugar chain structures are site-specifically labeled with a stable isotope, fragmenting the sugar chains, and then obtaining fragment types and the ratios of the fragments. The ratio of each fragment can be expressed as a relative signal intensity ratio of each fragment as obtained by mass spectrometry. Preferably, a fragmentation pattern template contains fragment types obtained by fragmentation of a sugar chain, preferably the structure types of the fragments and their signal intensity ratios in mass spectrometry. A signal intensity ratio can be expressed as relative % with respect to the total of the signal intensities, or as relative % with respect to specific signal intensity, preferably the maximum signal intensity, for example. However, the examples are not limited thereto. The basic structure of a sugar chain, mass spectrometry, and signal intensity ratio are as described above.

For example, for a glycoprotein sugar chain, a fragmentation pattern template is generated for each basic structure observed in N-linked and O-linked sugar chains. More specifically, a complex type N-linked sugar chain has any of mono- to penta-antennary (single- to five-stranded) branch structures. With the use of these mono- to penta-antennary (single- to five-stranded) branch structures as basic structures, fragmentation pattern templates are generated in advance for each branch structure. Furthermore, it is preferable to generate a fragmentation pattern template for each type of GlcNAc glycosidic bond at a branch site. If certain fragmentation pattern templates can be obtained for each structure in the periphery of the core pentasaccharide, fragmentation patterns can be automatically generated for structures having further extends or branches at its termini and then accumulated as data.

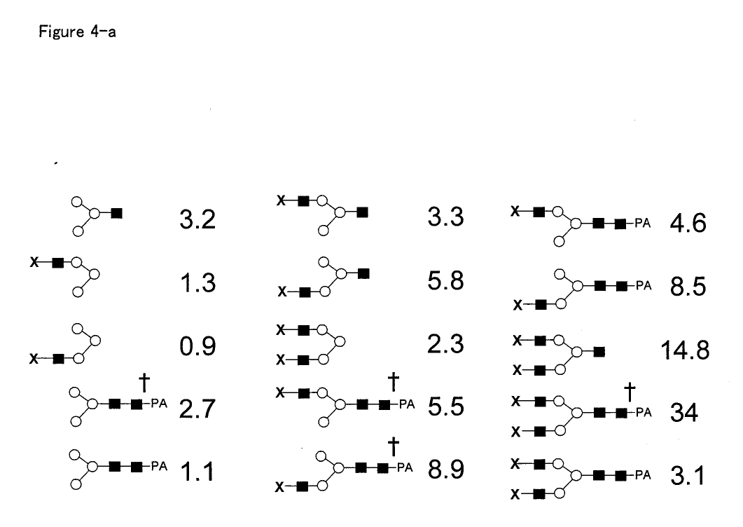

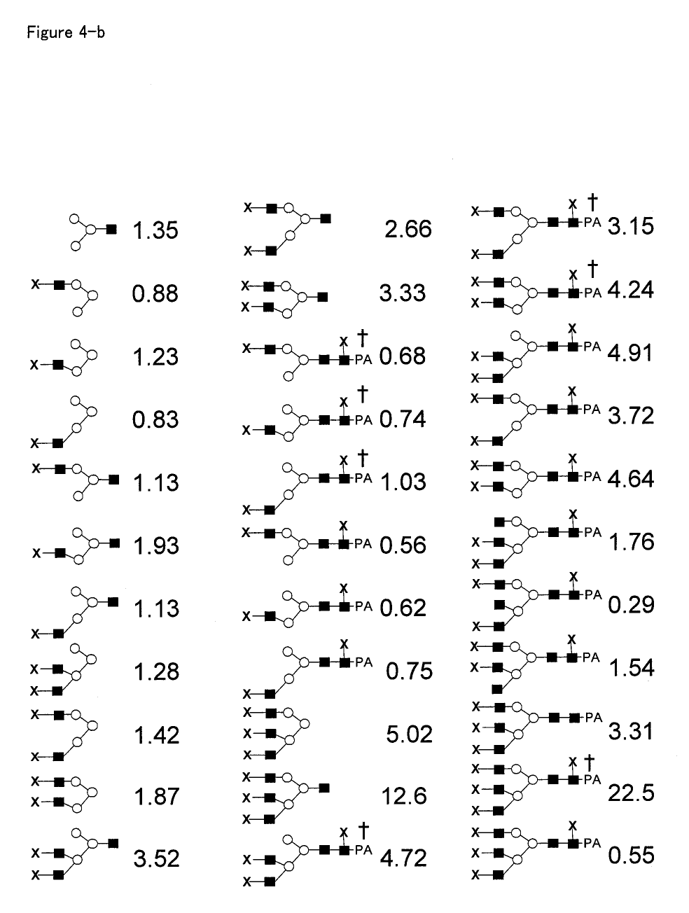

FIG. 4a shows an example of a fragmentation pattern template of a biantennary complex type N-linked sugar chain. FIG. 4b shows an example of a fragmentation pattern template of a triantennary complex type N-linked sugar chain.

Subsequently, the fragmentation pattern template of a sugar chain that has the same basic structure as that of a target sugar chain is selected from among previously generated fragmentation pattern templates. For example, for a complex type N-linked sugar chain, the fragmentation pattern template of a sugar chain having the same branch structure as that of a target sugar chain is selected. Next, based on the thus selected template, the fragmentation pattern of the target sugar chain is predicted. Specifically, the structure of a sugar chain that is the source of the selected template is compared with the structure of the target sugar chain. Based on the points of agreement and points of difference between the two, the fragmentation pattern can be predicted based on fragment structures in the structure of the sugar chain that is the source of the selected template and the signal intensity ratios of the fragments.

The sugar chain fragmentation patterns generated through prediction based on such templates can be used as predicted fragmentation pattern data in the method for analyzing sugar chain structure and the system for analyzing sugar chain structure in I above.

The present invention further relates to a system for carrying out the above method for predicting a fragmentation pattern; that is, an apparatus for generating a predicted fragmentation pattern. The system for predicting the fragmentation pattern of a sugar chain of the present invention comprises:

a template memory device for storing fragmentation pattern templates;
a matching apparatus for selecting a template of a sugar chain having the same basic structure as that of a target sugar chain from templates stored in the template memory device;
a fragmentation pattern generation apparatus for generating the fragmentation pattern of the target sugar chain based on the template selected in the matching apparatus; and
a fragmentation pattern display device for displaying the thus obtained fragmentation pattern.

The template memory device is a device for storing a plurality of fragmentation pattern templates generated in advance. As such device, a device that is generally used in the art can be used. Examples of such device include hard disks and memories.

The matching apparatus is an apparatus for comparing the basic structures of a target sugar chain with the basic structures of sugar chains that may be the source of fragmentation pattern templates stored in the template memory device and then selecting the template of a sugar chain having the same basic structure as of the target sugar chain. Comparison and selection are carried out via software. For example, when the fragmentation pattern of a complex type N-linked sugar chain is predicted, comparison of basic structures is carried out via comparison of branch structures and then a template having the same branch structure is selected.

The apparatus for generating a fragmentation pattern is an apparatus for comparing the structure of a sugar chain that is the source of a template selected in the matching apparatus with the structure of a target sugar chain and then, based on points of agreement and points of difference between the two, generating a predicted fragmentation pattern based on fragment structures in the structure of the sugar chain that is the source of the template and the signal intensity ratios of the fragments. Generation of a fragmentation pattern is carried out via software.

The fragmentation pattern display device is a device for displaying a fragmentation pattern generated by the apparatus for generating a fragmentation pattern, that is, a predicted fragmentation pattern. As such device, a device that is generally used in the art can be used. An example of such device is a display.

The present invention is hereafter described in greater detail with reference to the following examples, although the scope of the present invention is not limited thereto.

### EXAMPLES

### Example 1

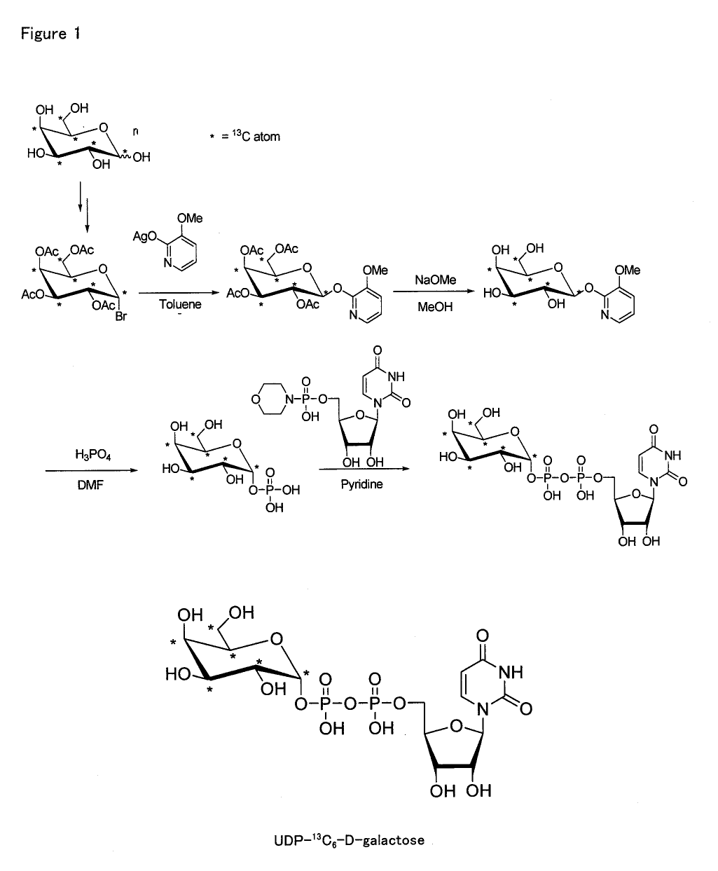

A sugar donor (UDP-¹³C₆-D-galactose) labeled with a stable isotope was synthesized (B. Lou, G. V. Reddy, H. Wang, and S. Hanessian, in Preparative Carbohydrate Chemistry (Ed.: S. Hanessian), Dekker, New York, 1996, pp. 389-412, S. Hannesian, P-P. Lu, and H. Ishida, J. Am. Chem. Soc. 1998, 120, 13296-13300). With the use of the sugar donor (FIG. 1), biantennary, triantennary, and tetraantennary N-linked oligosaccharides site-specifically labeled with an isotope were synthesized using β4-galactosyltransferase I (FIG. 2). These sugar chains have ¹³C₆-galactose residues at complementary positions. Glycosyltransferase has high-degree of substrate specificity and structural specificity, and selectively and quantitatively generates the Galβ1→4GlcNAc structure through the transfer of a Gal residue to GlcNAc.

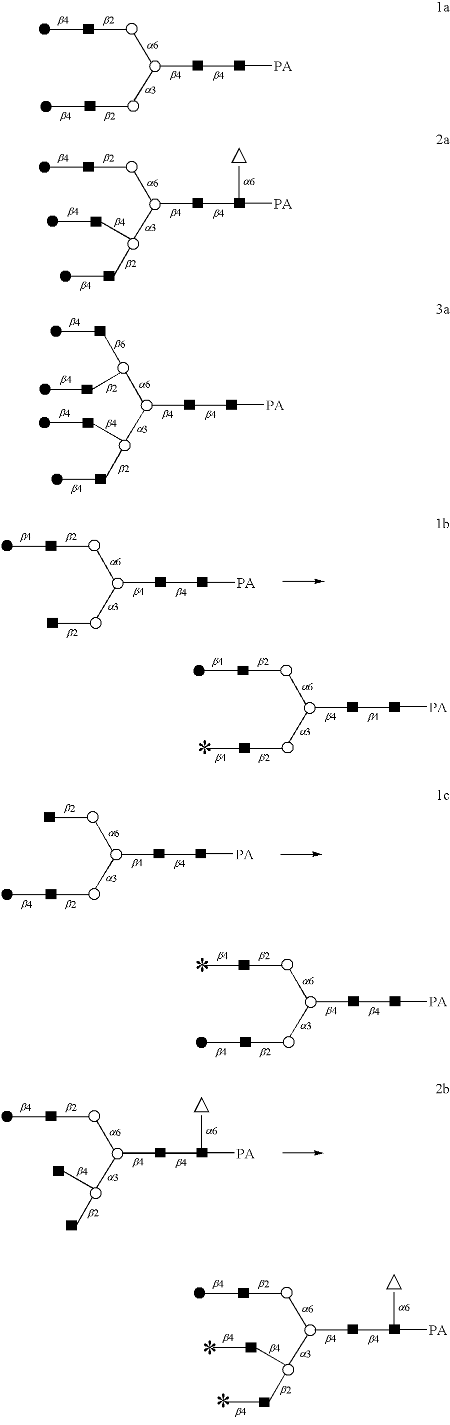

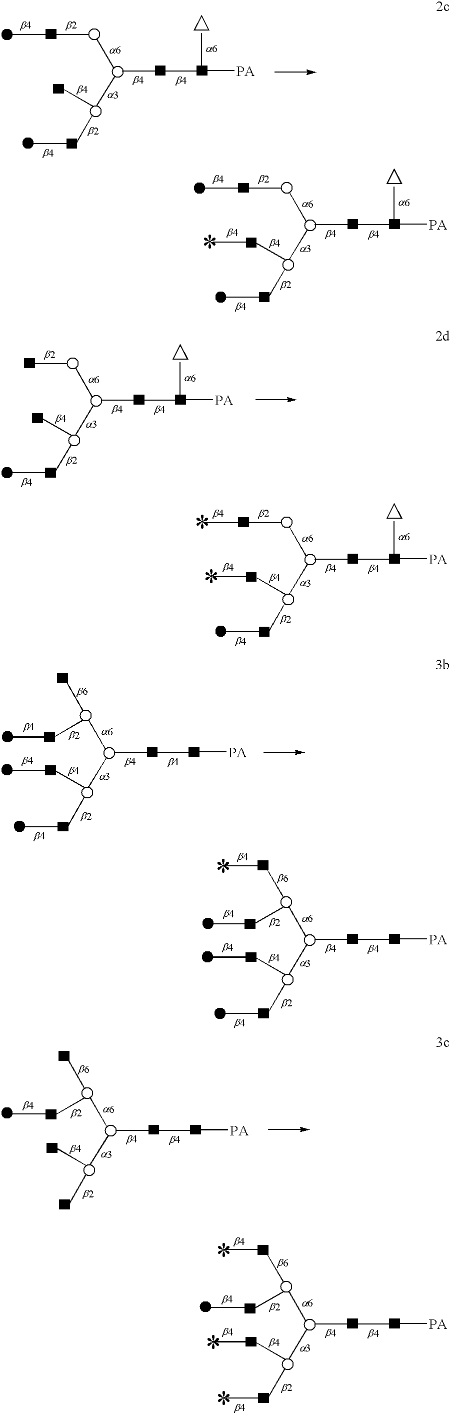

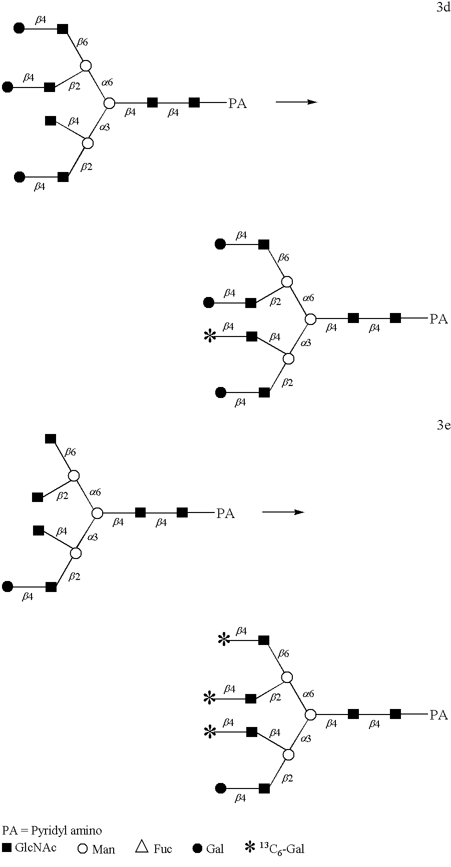

An [M+Na]⁺ ion was used as a parent ion for a CID spectrum. Mass spectrometry was carried out by matrix-assisted laser desorption/ionization quadrupole ion trap time-of-flight mass spectrometry (MALDI-QIT-TOF MS). Fragmentation patterns that had been obtained at the CID energy where the intensity of the parent ion had almost disappeared were reproducible. FIG. 3a shows the signal intensity derived from each fragment ion in the CID spectrum of the biantennary N-linked oligosaccharide of 1a. This is based on signal intensity ratios derived from the corresponding fragments in the CID spectrum of 1b and that of 1c. Regarding all the three signals, a fragment ion resulting from the dissociation of a Galβ1→4GlcNAc residue on the Manα1→6 branch side had a higher signal intensity ratio than those of other fragment ions having the same composition. Moreover, similar results were also observed in CID spectrum (MS3 spectrum) for which a fragment ion (m/z 1443) had been used as a parent ion (FIG. 3b). Furthermore, 1b and 1c exerted almost the same dissociation tendency. This indicates that the ¹³C isotope did not affect fragmentation.

Therefore, it was demonstrated that the signal intensity ratios of fragment ions having the same composition can be measured based on signal intensity ratios obtained from an oligosaccharide set having identifiable galactose (¹³C₆ or ¹³C₆) at complementary positions in the branch structures.

To analyze the tendency of the dissociation of triantennary and tetraantennary N-linked oligosaccharides, an experiment was conducted for 2a to 3e (FIG. 2) by CID. FIGS. 3c and 3d summarize the signal intensity ratio of each fragment ion with respect to those of the signals generated by dissociation of the GlcNAcβ1→2 bond of 2a and that of 3a. Dissociation tendency differed depending on N-linked oligosaccharide branch types. This was almost independent from the structure of the reduction site of the mannose core. These results demonstrate that major differences in fragmentation patterns are due to differences in tendency of dissociation of a GlcNAc glycosidic bond at a branch site.

It was considered that 1a, 2a, and 3a structures can be basic structures of a complex type N-linked oligosaccharide. Variations of an N-linked oligosaccharide are generally due to elongation of nonreducing termini in these basic structures. Therefore, fragmentation pattern template data for these basic structures are useful for predicting a fragmentation pattern of an arbitrary structure of an N-linked oligosaccharide.

### Example 2

To demonstrate the above conclusion, fragmentation pattern templates of the basic structures of N-linked oligosaccharides were generated (FIG. 4). Such a template is composed of precise attributes of each fragment ion and contains branching topology, the signal intensity ratios (%) derived from each fragment ion with respect to the total of signal intensities calculated from the experimental data obtained using the above stable isotope.

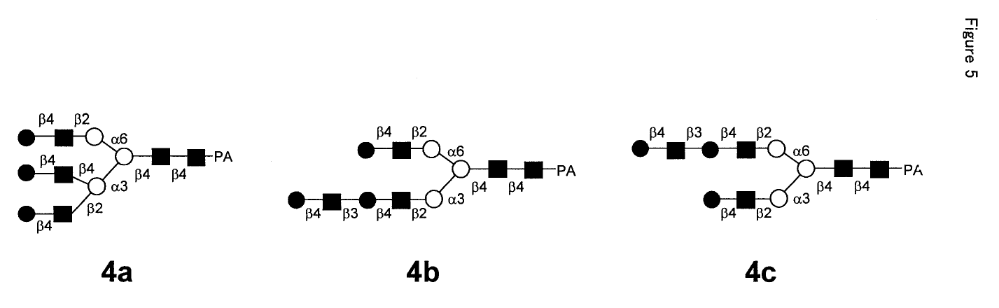

With the use of these templates, CID spectra were obtained for three types of isomer; that is, prediction of fragmentation patterns was carried out (FIG. 5). They were oligosaccharides having the same composition, but they had different topologies. 4b and 4c were synthesized as follows.

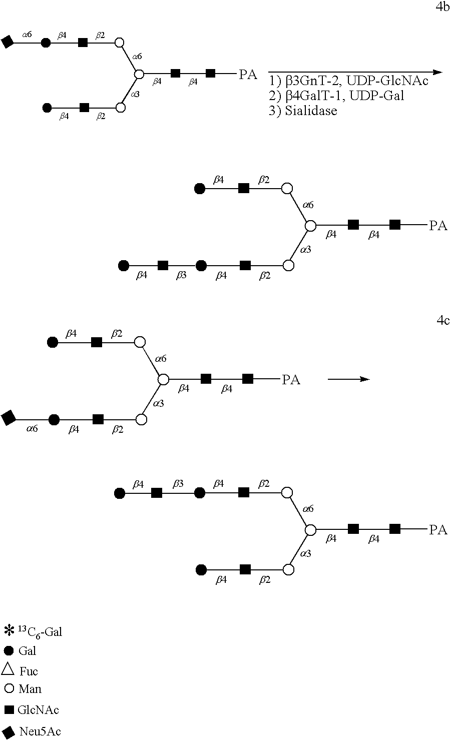

A PA (pyridylamino)-labeled monosialo biantennary N-linked oligosaccharide (TAKARA BIO INC.) was subjected to N-acetylglucosaminylation using β3-N-acetylglucosaminyltransferase 2 and UDP-D-GlcNAc. The product was isolated by HPLC and then galactose was added to a nonreducing terminal GlcNAc residue using β4-galactosyltransferase I. Finally, a Neu5Ac residue was removed via neuraminidase treatment and then the product was purified by HPLC. Thus, 4b and 4c were obtained.

Signal intensity ratios were assigned to fragment ions virtually obtained from these three types of isomer based on the templates of corresponding basic structures. For each predicted CID spectrum, the m/z values and the signal intensity ratios (%) of virtual fragment ions were plotted. Fragment ions having the same m/z value were represented by a total of signal intensity ratios. In the thus predicted spectra, significant differences were observed among three types of isomer in terms of signal intensity ratios of the fragment ions of m/z 1376 and m/z 1741, as well as the corresponding dehydration ions (FIG. 6a). Specifically, the ratio of the sum of the signal intensities of the fragment ions of m/z 1376 and the corresponding dehydration ions thereof to the sum of the signal intensities of the fragment ions of m/z 1741 and the corresponding dehydration ions thereof was 0.17 in the case of 4a, 0.57 in the case of 4b, and 1.82 in the case of 4c. This was the largest point of difference observed among the three predicted spectrum types.

To confirm whether such differences were also reflected to actual spectra (that is, actual fragmentation patterns), MALDI-QIT-TOF-MS was carried out for these three types of isomer that had been enzymatically synthesized. As shown in FIG. 6b, also in the actual spectra, fragmentation patterns similar to those in the simulated spectra were obtained. In particular, similar patterns were obtained concerning the points of difference among isomers predicted in the simulation. Based on the above results, it was demonstrated that according to the present invention, the fragmentation pattern of an N-linked oligosaccharide can be predicted.

The amount of each sample was always 1 picomole in the above experimentation. It was thus demonstrated that according to the present invention, the structure of a sugar chain can be analyzed with a very small amount of a sample.

### Example 3

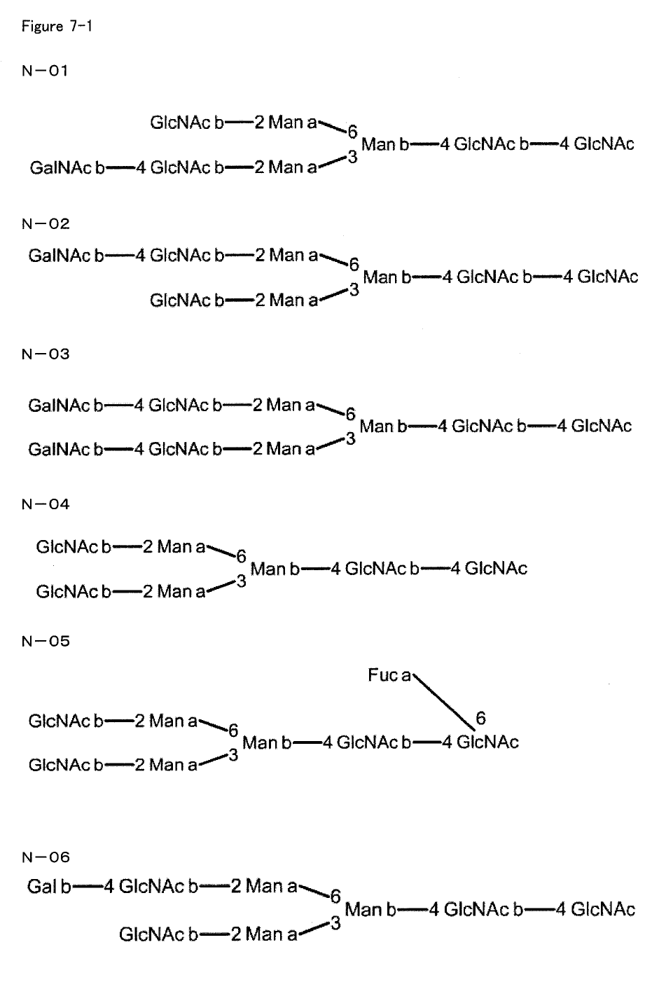

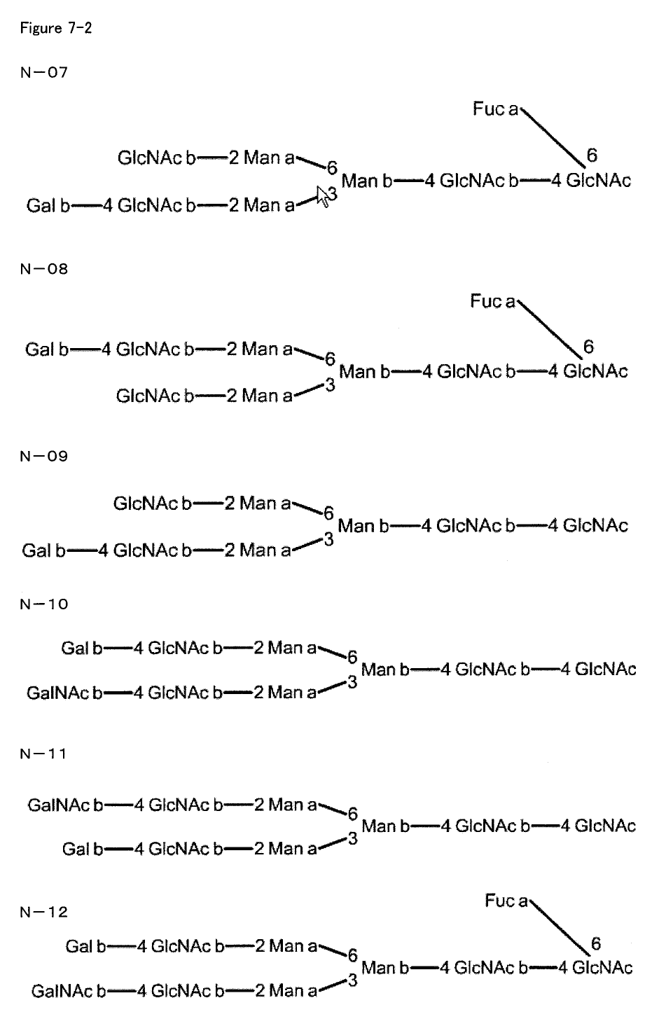

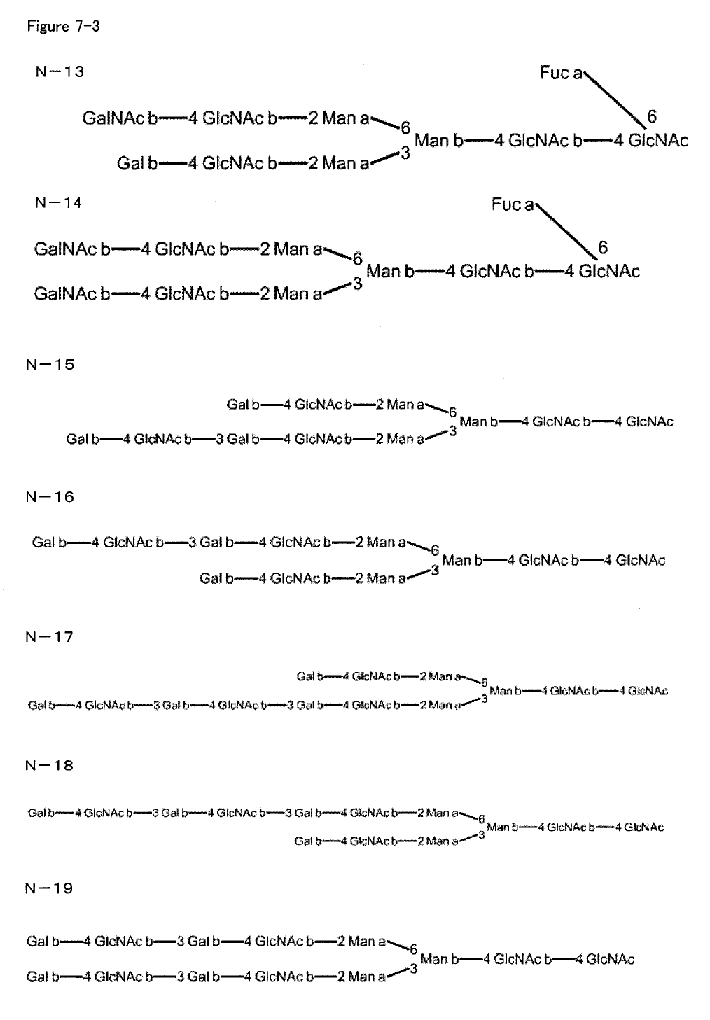

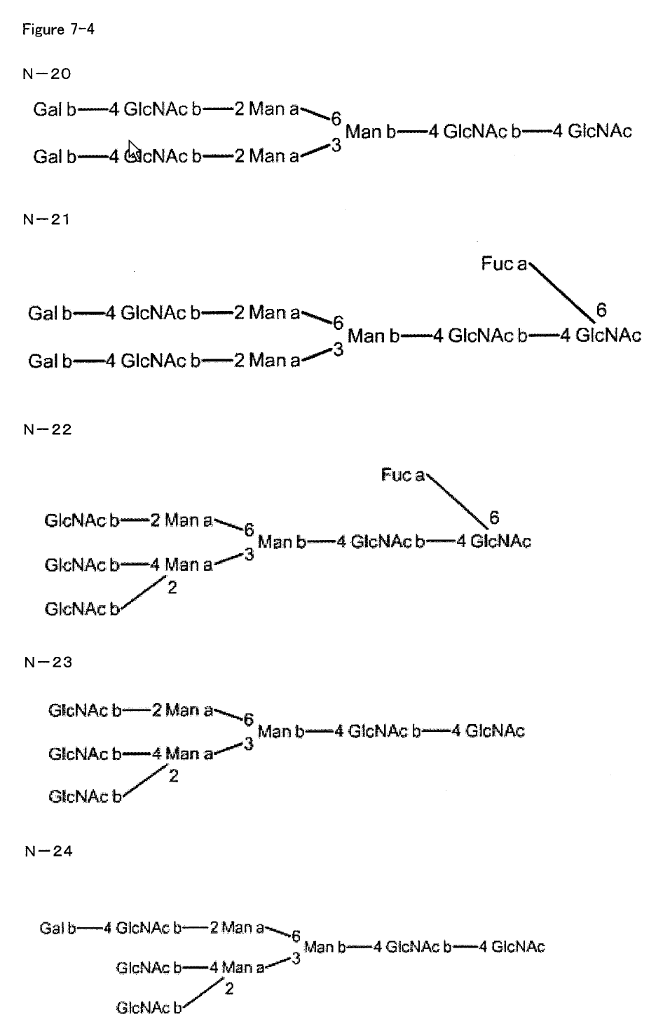

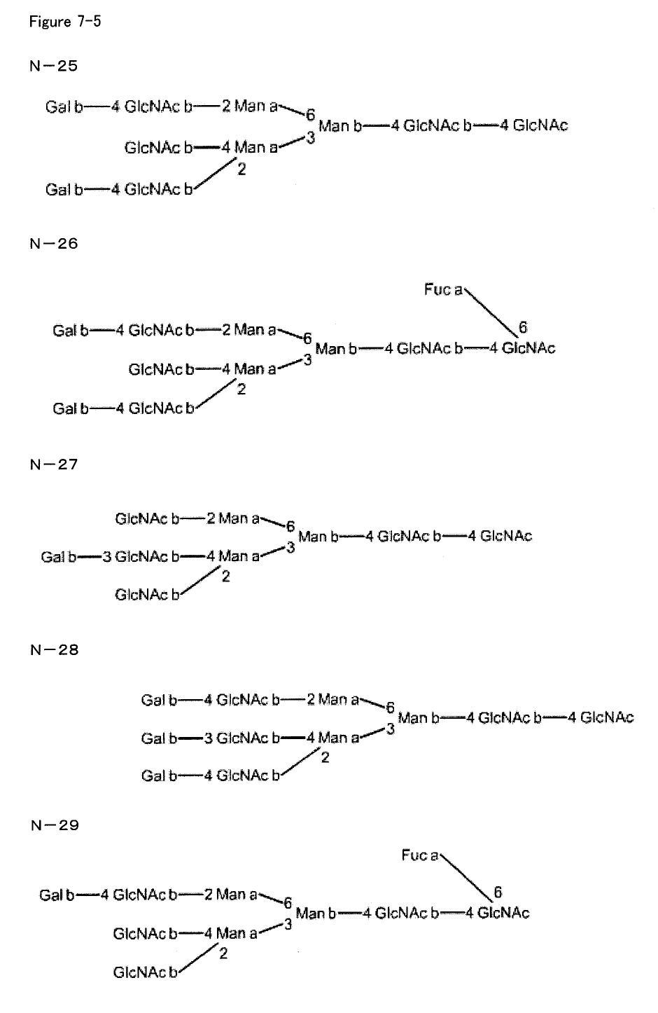

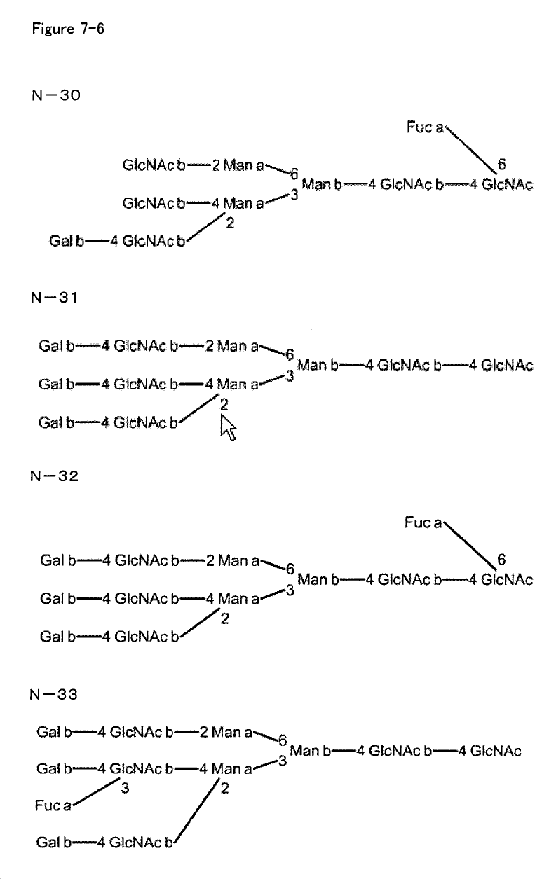

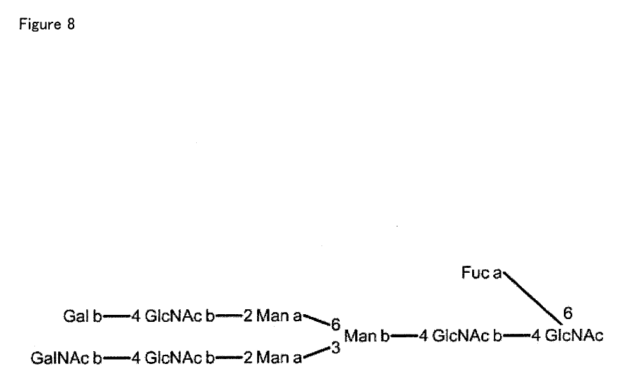

To demonstrate sugar chain structural analysis performed using predicted fragmentation patterns of many sugar chains stored in a device, signal intensity ratios were assigned to fragment ions virtually obtained from each sugar chain structure shown in FIG. 7 based on the template of the corresponding basic structure. The m/z values of virtual fragment ions and their signal intensity ratios (%) were plotted, so that predicted spectrum for each sugar chain structure (that is, predicted fragmentation patterns) was generated. All the thus produced predicted spectra were stored in the memory device. A test sugar chain (FIG. 8) prepared by the method described in the relevant literature (Sato, T. et al., J. Biol. Chem., 2003, 278, p. 47534) was analyzed by MALDI-QIT-TOF-MS, so that the actual fragment spectrum (actual fragmentation pattern) of the sugar chain was obtained (FIG. 9). Among the stored predicted spectra, four predicted spectrum types (N-11, N-12, N-29, and N-30) were found. They were predicted spectra of parent ions having a molecular weight (m/z 1928) that was same as that of the test sugar chain. Fragmentation pattern matching of these four predicted spectrum types with the actual spectrum of the test sugar chain was carried out by the method described below.

(1) Regarding the actual spectrum of a test sugar chain, the integer portion of the m/z value of each fragment ion at the monoisotopic peak was determined to be the m/z value of the fragment ion. A total of relative intensities at all isotopic peaks was determined to be the relative intensity of the fragment ion.
(2) When the relative intensities of n (=number of peaks) peaks (P1, P2, . . . Pn) in the predicted spectrum are xi (i=1 to n), vector X of the spectrum is produced as:

X=(x1, x2, . . . xn).

(3) Regarding the actual spectrum of a test sugar chain, a peak having an m/z value corresponding to that of the peak Pi of the predicted spectrum is determined, and vector Y of the spectrum is produced from the relative intensities of the peaks as:

Y=(y1, y2, . . . yn).

(4) Dissimilarity index D1 (of differences) between the spectra is obtained from the Euclidean distance between the two vectors X and Y as follows:

D1=Σ(I=1 to n)(xi−yi)².

The value D1 calculated herein is 0 (zero) when both spectra are completely the same and the value D1 becomes larger as the difference between the two spectra becomes larger. Hence, the value D1 is expressed as a “dissimilarity index.” Naturally, the value can be a measure of similarity between the two spectra.

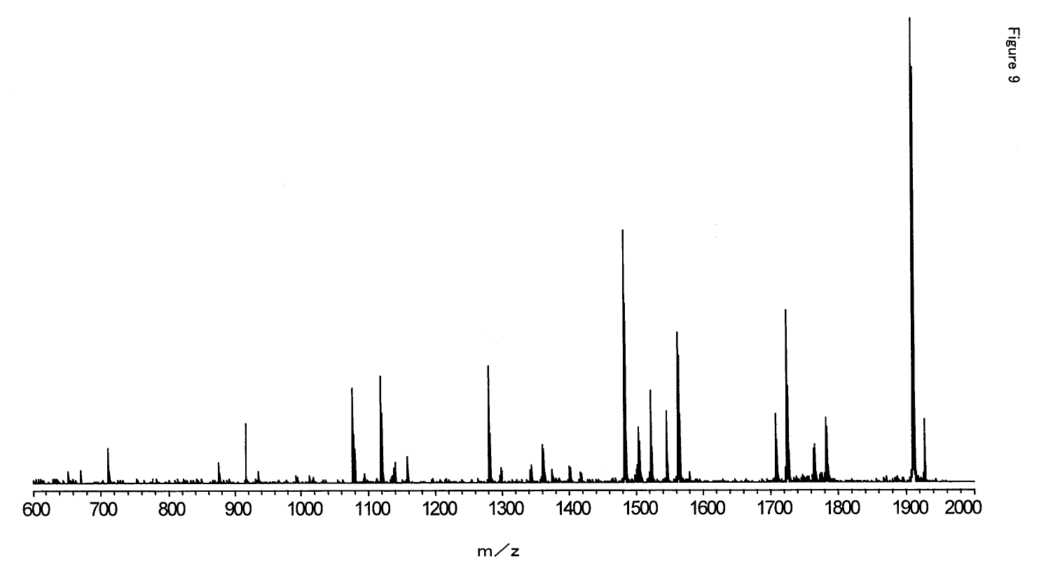

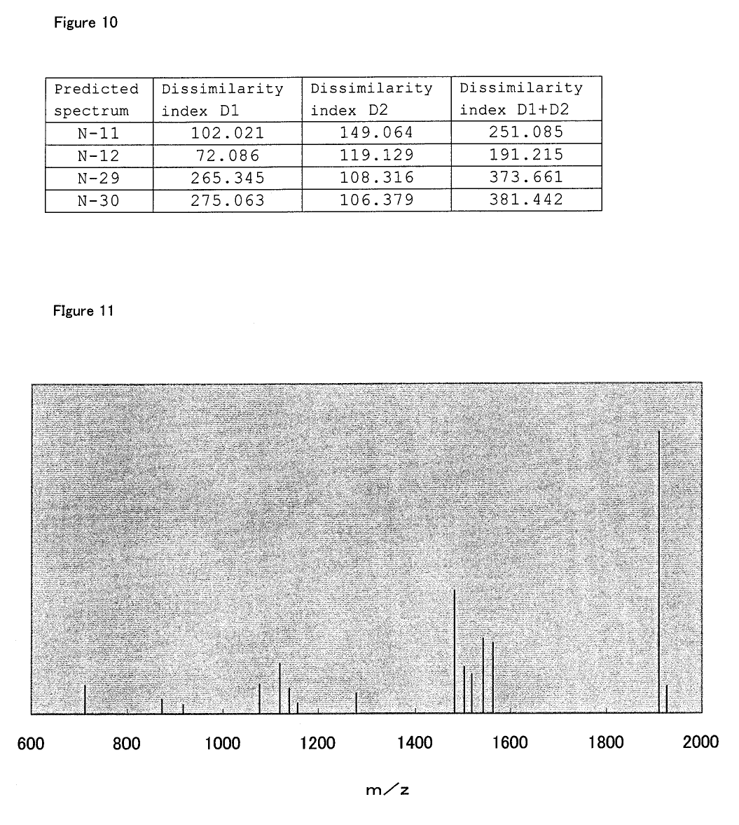

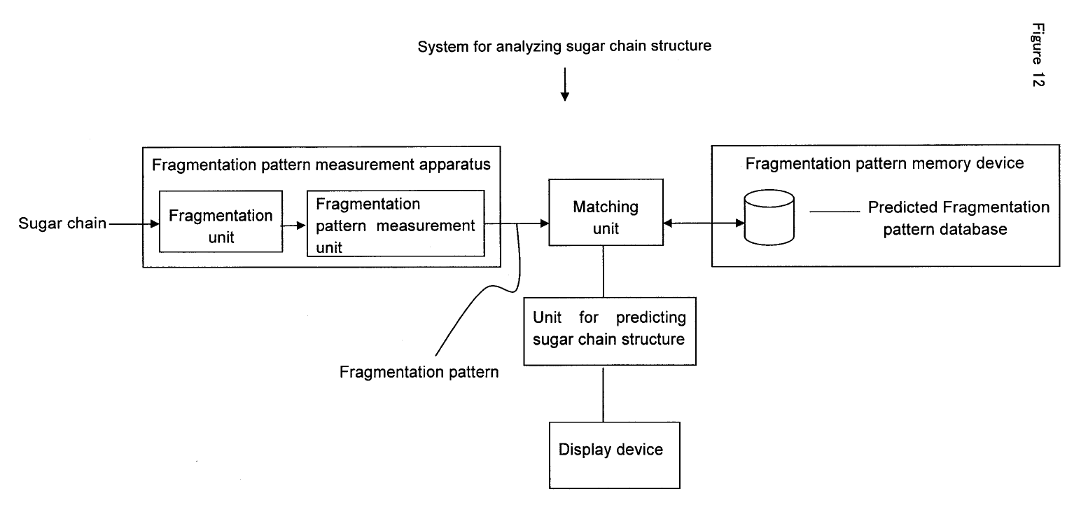

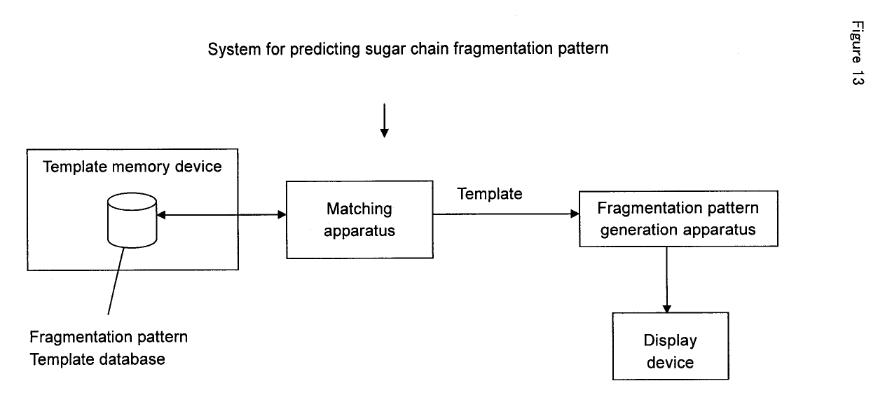

(5) The use of the dissimilarity index D1 calculated as described above results in a low dissimilarity index even when the actual spectrum includes many peaks that are absent in the predicted spectrum. Thus, a dissimilarity index D2 is calculated again by exchanging the vector calculation method of the actual spectrum with that of the predicted spectrum. That is, the above vector X is calculated from the actual spectrum, the above vector Y is calculated from the predicted spectrum, and then the dissimilarity index D2 is obtained. FIG. 10 shows the results of fragmentation pattern matching with the actual spectrum of a test sugar chain. Regarding the sum of D1+D2, the predicted spectrum of N-12 showed the smallest sum of D1+D2 among four predicted spectrum types. FIG. 11 shows the predicted spectrum of N-12. The sugar chain structure of N-12 had the same structure as that of the test sugar chain. It was thus demonstrated that a sugar chain structure can be precisely analyzed via matching of many stored predicted spectra with an actual spectrum.

All publications, patents, and patent applications cited in this specification are herein incorporated by reference in their entirety.

1. A method for analyzing sugar chain structure, comprising a step of obtaining the fragmentation pattern of a test sugar chain through fragmentation of the test sugar chain and a step of predicting the structure of the test sugar chain through comparison of sugar chain predicted fragmentation pattern data generated based on fragmentation pattern templates with the fragmentation pattern of the test sugar chain.

2. The method according to claim 1, wherein the test sugar chain quantity ranges from 0.01 picomoles to 100 picomoles.

3. The method according to claim 1, wherein the step of obtaining the fragmentation pattern of a test sugar chain through fragmentation of the test sugar chain includes a step of obtaining the mass and the signal intensity of each fragment through analysis of the fragmented test sugar chain in a mass spectrometer.

4. The method according to claim 3, wherein the step of predicting the structure of the test sugar chain is a step of predicting sugar chain structure through comparison of the signal intensity ratios of fragments in the fragmentation patterns.

5. A system for analyzing sugar chain structure, comprising
a fragmentation pattern measurement apparatus for fragmenting a test sugar chain and measuring the fragmentation pattern of the fragmented test sugar chain,
a fragmentation pattern memory device for storing sugar chain predicted fragmentation pattern data generated based on fragmentation pattern templates,
a matching apparatus for comparing the predicted fragmentation pattern data stored in the fragmentation pattern memory device with the fragmentation pattern measured using the apparatus for measuring a fragmentation pattern,
and a sugar chain structure display device for displaying the sugar chain structure predicted based on comparisons made in the matching apparatus.

6. The system for analyzing sugar chain structure according to claim 5, wherein the apparatus for measuring a fragmentation pattern is a mass spectrometer.

7. The system for analyzing sugar chain structure according to claim 6, wherein the matching apparatus is an apparatus for comparing the signal intensity ratios of fragments in the fragmentation patterns.

8. The system for analyzing sugar chain structure according to claim 5, wherein the apparatus for measuring a fragmentation pattern contains a collision-induced dissociation apparatus.

9. A method for predicting the fragmentation pattern of a sugar chain, comprising
a step of selecting a fragmentation pattern template of a sugar chain having the same basic structure as that of a target sugar chain, and
a step of generating the fragmentation pattern of the target sugar chain based on the selected template.

10. A system for predicting the fragmentation pattern of a sugar chain, comprising
a template memory device for storing fragmentation pattern templates,
a matching apparatus for selecting a template of a sugar chain having the same basic structure as that of a target sugar chain from the templates stored in the template memory device,
a fragmentation pattern generation apparatus for generating the fragmentation pattern of the target sugar chain based on the template selected in the matching apparatus, and
a fragmentation pattern display device for displaying the thus obtained fragmentation pattern.
